(19) United States
(12) Patent Application Publication
(10) Pub. No.: US 2016/0050074 A1
(43) Pub. Date: Feb. 18, 2016

(54) CONTENT TRACEABILITY USING SEGMENTED WATERMARK ENCODING

(71) Applicant: ARRIS Enterprises, Inc., Suwanee, GA (US)

(72) Inventor: David Alfred Romrell, Hillsboro, OR (US)

(21) Appl. No.: 14/459,538

(22) Filed: Aug. 14, 2014

(51) Int. Cl. H04L 9/32

(52) U.S. Cl. CPC H04L 9/3247; H04L 2209/608; H04L 2209/72

(57) ABSTRACT

The system for content traceability using segmented watermark encoding disclosed herein provides a method for applying a distinct identifier to digital content, such that the a copy of the digital content can be traced to the original recipient of the content. The method comprises generating multiple copies of the digital content and applying distinct digital watermarks to each copy. The method further comprises interleaving segments of each digitally watermarked copy in a pattern that represents a unique identifier, to create a distinctly identifiable copy of the digital content. The identifier can be extracted from a distinctly identified copy of the digital content by examining the watermark applied to each segment that comprises the digital content.

Content creators require the ability to detect when copyrighted material is being copied and/or distributed without authorization. Covert digital watermarks are used to detect, identify, and remove such content.

Digital watermarks can be uniquely associated with a distribution path. A system employing such watermarks can help to identify by which path an unauthorized copy came. The content owner or service operator for a given distribution path, however, will not be able to determine which particular client with access to that content was directly responsible for making an unauthorized copy.

Creating a unique watermark for each content instance delivered to a client can resolve the specific client making unauthorized copies. However, generating a per-instance unique watermark can be prohibitive both in data processing cost and delays.

The embodiments disclosed herein describe interleaving segmented content with distinct watermarks as an efficient method to encode a unique watermark to allow more specific content traceability.

### SUMMARY

In one embodiment, a computer-implemented method for content traceability using segmented watermark encoding is disclosed. The computer-implemented method comprises preparing at least two distinct digitally watermarked copies of digital content, wherein each one of the at least two digitally watermarked copies comprises a distinct digital watermark, and wherein each one of the at least two digitally watermarked copies comprises a plurality of distinct segments. The computer-implemented method further comprises interleaving at least one corresponding segment from at least one of the at least two digitally watermarked copies. The computer-implemented method further comprises generating a pattern that represents a unique identifier based on a position of the interleaved segment in at least one of the digitally watermarked copies of the digital content.

In one embodiment, an apparatus for content traceability using segmented watermark encoding is disclosed. The apparatus comprises a processor and a memory coupled to the processor. In some embodiments the memory stores program instructions. The program instructions, when executed from the memory, cause the processor to prepare at least two distinct digitally watermarked copies of digital content, wherein each one of the at least two digitally watermarked copies comprises a distinct digital watermark, and wherein each one of the at least two digitally watermarked copies comprises a plurality of distinct segments. The program instructions further cause the processor to interleave at least one corresponding segment from at least one of the at least two digitally watermarked copies. The program instructions further cause the processor to generate a pattern that represents a unique identifier based on a position of the interleaved segment in at least one of the digitally watermarked copies of the digital content.

In one embodiment, a system for content traceability using segmented watermark encoding is disclosed. The system comprises a digital content server configured to create and deliver uniquely identifiable copies of digital content. The digital content server comprises a processor a memory coupled to the processor. In some embodiments the memory stores program instructions. The program instructions, when executed from the memory, cause the processor to prepare at least two distinct digitally watermarked copies of digital content, wherein each one of the at least two digitally watermarked copies comprises a distinct digital watermark, and wherein each one of the at least two digitally watermarked copies comprises a plurality of distinct segments. The program instructions further cause the processor to interleave at least one corresponding segment from at least one of the at least two digitally watermarked copies. The program instructions further cause the processor to generate a pattern that represents a unique identifier based on a position of the interleaved segment in at least one of the digitally watermarked copies of the digital content.

The foregoing summary is illustrative only and is not intended to be in any way limiting. In addition to the illustrative aspects, embodiments, and features described above, further aspects, embodiments, and features will become apparent by reference to the drawings and the following detailed description.

### FIGURES

The novel features of the embodiments described herein are set forth with particularity in the appended claims. The embodiments, however, both as to organization and methods of operation may be better understood by reference to the following description, taken in conjunction with the accompanying drawings as follows.

FIG. 1 illustrates an embodiment of content traceability using segmented watermark encoding using two watermarked copies of the digital content;

FIG. 2 illustrates an embodiment of content traceability using segmented watermark encoding using three watermarked copies of the digital content;

FIGS. 3A-3C illustrate various embodiments for locating an identifier patter in any given portion of a digital content;

FIG. 4 illustrates a process for delivering uniquely identifiable content using segmented watermark encoding employing a manifest manipulator according to one embodiment;

FIG. 5 illustrates a process for delivering uniquely identifiable content using segmented watermark encoding employing a manifest selector according to one embodiment;

FIG. 6 illustrates a process 600 for delivering uniquely identifiable content using segmented watermark encoding employing a session proxy according to one embodiment;

FIG. 7 illustrates a process 700 for delivering uniquely identifiable content using a MPTS server according to tone embodiment;

FIG. 8 illustrates a process 800 for delivering uniquely identifiable content using an MTPS splicer according to one embodiment;

FIG. 9 illustrates a logic diagram of a computer-implemented method for delivering uniquely identifiable content according to one embodiment;

FIG. 10 illustrates a logic diagram of a computer-implemented method for identifying uniquely identifiable content according to one embodiment; and

FIG. 11 illustrates an architectural or component view of a computing system that may be employed with the computer-implemented method for delivering uniquely identifiable content according to one embodiment.

### DESCRIPTION

Digital Watermarking

Digital watermarking is the practice of hiding a message about an image, audio clip, video clip, or other digital content within the content itself. Digital watermarking is distinguishable from other methods of attaching information to data in at least three ways: first, the watermark is meant to be imperceptible when the data to which it is attached is in normal use; second, the watermark is inseparable from the data in which it is embedded; and third, the watermark can undergo the same transformations as the data itself. This means that it is sometimes possible to learn something about those transformations by examining the watermarks. The preservation of the watermark when content is copied and/or undergoes transformations allows content providers, for example, to identify and enforce copyright protection.

Digital watermarking systems can be characterized by a number of defining properties. One such property is fidelity, which refers to the perceptual similarity between the original content and the watermarked copy of the content. In some situations the content may be degraded during transmission, in which case low fidelity is acceptable, and some visible distortion caused by a watermark is acceptable. In other applications the watermarked content will reach its final destination in nearly identical form as the original content, in which case high fidelity (that is, an imperceptible watermark) is desirable.

The cost of high fidelity, however, can be robustness, another property of digital watermarking systems. Robustness is the ability to detect the watermark after common signal processing operations. Examples of common operations in images include spatial filtering, lossy compression, printing and scanning, and geometric distortion (rotation, translation, scaling, and so on). Video watermarks may need to be robust to many of the same transformations, as well as to recording on video tape and changes in frame rate, among other influences. Audio watermarks may need to be robust to such processes as temporal filtering, recording on audio tape, and variations in playback speed that result in wow and flutter. The opposite of a robust watermark is a fragile watermark. Fragile watermarks fail to be detectable after the slightest modification. Fragile watermarks can be used for applications such as tamper detection.

Another property of watermarks is security. Security refers to the ability of a watermark to resist hostile attack. A hostile attack is any process specifically intended to thwart the watermark's purpose. Types of attacks can be broadly categorized as unauthorized removal and unauthorized embedding, which modify the underlying data, and unauthorized detection, which does not modify any data. Security can also come at a cost to fidelity.

Various methods exist for embedding a watermark in still images, video, audio, text, and 3-D models. A digital watermarking method is referred to as spread-spectrum if the marked signal is obtained by an additive modification. Spread-spectrum watermarks are known to be modestly robust, but also to have a low information capacity due to host interference. A digital watermarking method is said to be of quantization type if the marked signal is obtained by quantization. Quantization watermarks suffer from low robustness, but have a high information capacity due to rejection of host interference. A digital watermarking method is referred to as amplitude modulation if the marked signal is embedded by additive modification which is similar to spread spectrum method, but is particularly embedded in the spatial domain.

Video content may be divided into segments for ease and robustness of delivery. The segments may constitute 6-10 viewable seconds of data. A video can be delivered one segment at a time, and if any segment is lost in transmission it can be retransmitted. A list of the segments and the order in which they should be viewed can be, though need not be, stored in a manifest. It is understood that video content is only one form of digital content, and that any digital content can be similarly divided into segments of any convenient size.

Content Traceability Using Segmented Watermark Encoding

Certain embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting example embodiments. The features illustrated or described in connection with one example embodiment may be combined with the features of other embodiments. Such modifications and variations are intended to be included within the scope of the present disclosure.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present disclosure.

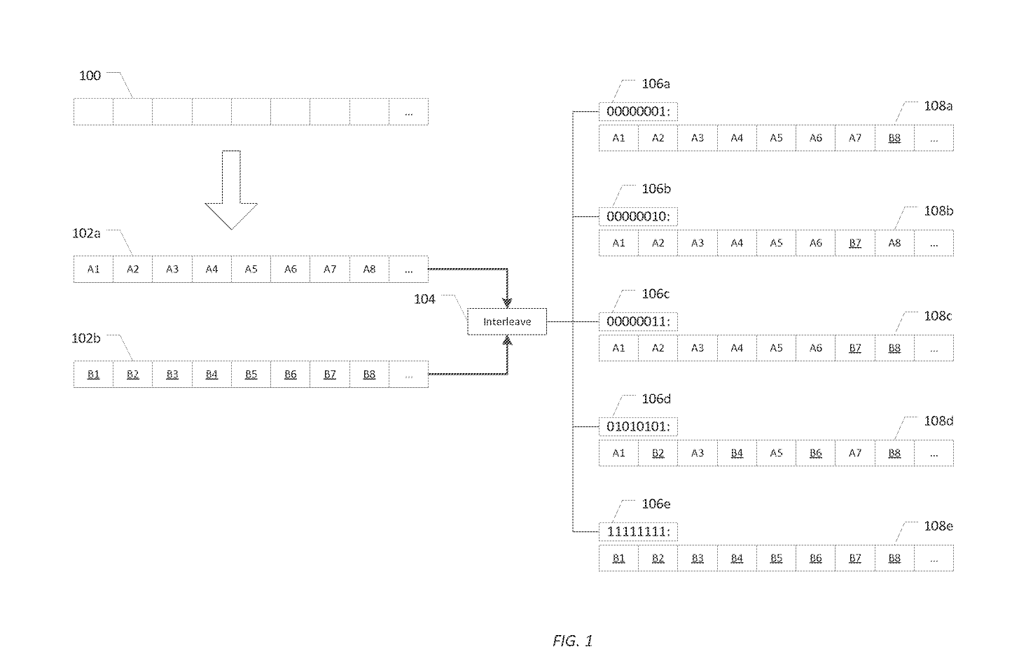

FIG. 1 illustrates an embodiment of content traceability using segmented watermark encoding. A content provider may create, derive, or be presented with multiple watermarked copies 102a and 102b of a digital content 100. Each watermarked copy 102a and 102b is identical to the digital content 100 in all respects except that the watermarked copies 102a and 102b have had a digital watermark applied to them. By way of example and not limitation, FIG. 1 illustrates an embodiment that employs two watermarked copies 102a and 102b of the digital content 100. Each watermarked copy 102a and 102b has a distinct watermark, such that one copy 102a is distinguishable from the other copy 102b. The watermarked copies 102a and 102b may be divided into segments, where each watermarked copy 102a and 102b is divided in an identical fashion, such that a segment from one copy 102a can be substituted with the same segment from the other copy 102b.

The digital content 100 may comprise any data that can be represented electronically. The digital content 100 can be video, audio, graphics, text, or any combination thereof. The digital content 100 may also contain multiple streams of data. The digital content 100 can be divided into logical segments representing a fixed or variable size, length, duration, number of bits, or any combination thereof. Watermarked copies 102a and 102b can be produced by copying the digital content 100 and applying a unique watermark to the copied data. Alternatively or additionally, the watermarked copies 102a and 102b can be produced by encoding unencoded data and applying the watermark during the encoding process. Additionally, a general watermark may also be applied to all watermarked copies 102a and 102b, where the general watermark can represent a distinct identification.

The watermarked copies 102a and 102b may be interleaved 104 according to an identifier 106a-106e. Each identifier 106a-106e may represent digital content user, a client device, a delivery method, a service, a service provider, a content provider, a content service provider, an internet protocol address, a timestamp, or any other identifiable entity, service, or technology, as appropriate, or any combination thereof. FIG. 1 illustrates five identifiers by way of example and not limitation, and it is recognized that the number of identifiers is limited only by the number of watermarked copies 102a and 102b provided.

An identifier 106a-106e determines the interleaving 104 pattern that will generate a uniquely identifiable copy 108a-108a of the digital content 100. For example, the digit zero can be used to identify the first watermarked copy 102a and the digit one can be used to identify the second watermarked copy 102b. Furthermore, the digits in the identifier 106a-106e read sequentially from left to right (or right to left) can be used to identify which watermarked copy 102a or 102b should provide the next segment in sequence. Thus, for the identifier 00000001 106a, the interleaving 104 step can select segments A1-A7 from the first watermarked copy 102a, followed by segment B8 from the second watermarked copy 102b. The resulting sequence of segments produces a uniquely identifiable copy 108a of the digital content 100. As another example, for the identifier 01010101 106d the interleaving 104 step can select A1, B2, A3, B4, A5, B6, A7, and B8. The digits zero and one are used here by way of example, and it is understood that any alphanumeric character or suitable symbol can be used to identify any watermarked copy 102a and 102b, as well as binary, octal, hexadecimal, decimal, or other numeric representation, alphanumeric representation, or predefined symbol. Furthermore, the identifier is given as eight digits by way of example only, and it is understood that the identifier can be any suitable length.

Because the watermarked copies 102a and 102b are divided into segments in a similar fashion, the resulting uniquely identifiable copies 108a-108e will be indistinguishable from the digital content 100 except for the digital watermarks. When the watermarks are decoded from the uniquely identifiable copies 108a-108e the embedded identifier 106a-106e can be extracted. To extract the embedded identifier 106a-106e, an operator can examine each segment of the uniquely identifiable copy 108a-108e and identify the watermark associated with each segment. Because each watermarked copy 102a and 102b had a unique watermark, the watermark associated with each segment of a uniquely identifiable copy 108a-108e can be related to the digits that identify the watermarked copy 102a and 102b. For example, the segments A1, A2, A3, A4, A5, A6, B7, A8 can be decoded to the identifier 00000010 106b. This identifier 106b can then be located in a database or directory of identifiers to determine for whom or what the uniquely identifiable copy 108b was generated.

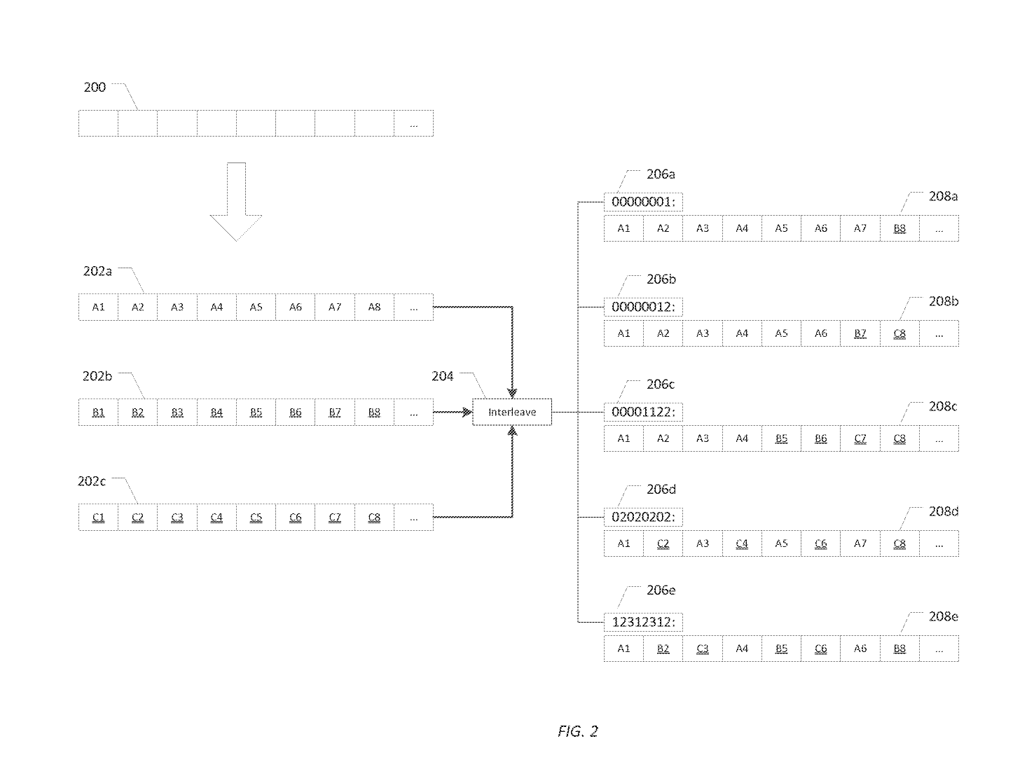

FIG. 2 illustrates an embodiment of content traceability using segmented watermark encoding. A content provider may create, derive, or be presented with three watermarked copies 202a-202c of a digital content 200. By way of example and not limitation, FIG. 2 illustrates an embodiment that employs three watermarked copies 202a-202c, and it is understood that a content provider can use whatever number of watermarked copies is desirable. Each watermarked copy 202a-202c is identical to the digital content 200 in all respects except that the watermarked copies 202a-202c have had a digital watermark applied to them. Each watermarked copy 202a-202c has a unique watermark, such that each copy is distinguishable from the other. The watermarked copies 202a-202c may be divided into identical segments, such that a segment from one copy can be substituted for the same segment of another copy.

The watermarked copies 202a-202c may be interleaved 204 according to an identifier 206a-206e. An identifier 206a-206e determines the interleaving 204 pattern that will generate a uniquely identifiable copy 208a-208e. For example, the digit zero can be used to identify the first watermarked copy 202a, the digit one can be used to identify the second watermarked copy 202b, and the digit two can be used to identify the third watermarked copy 202c. The identifier 00001122 206c therefore indicates that the interleaving 204 step should select segments A1, A2, A3, and A4 from the first watermarked copy 202a, then segments B5 and B6 from the second watermarked copy 202b, and then segments C7 and C8 from the third watermarked copy 202c. The resulting sequence of segments produces a uniquely identifiable copy 208c of the digital content 200. Because the watermarked copies 202a-202c are divided into segments in a similar fashion, the resulting uniquely identifiable copies 208a-208e are indistinguishable from the digital content 200 except for the digital watermarks. The embedded identifier 206a-206e can be extracted from the uniquely identifiable copies 208a-208e is described above.

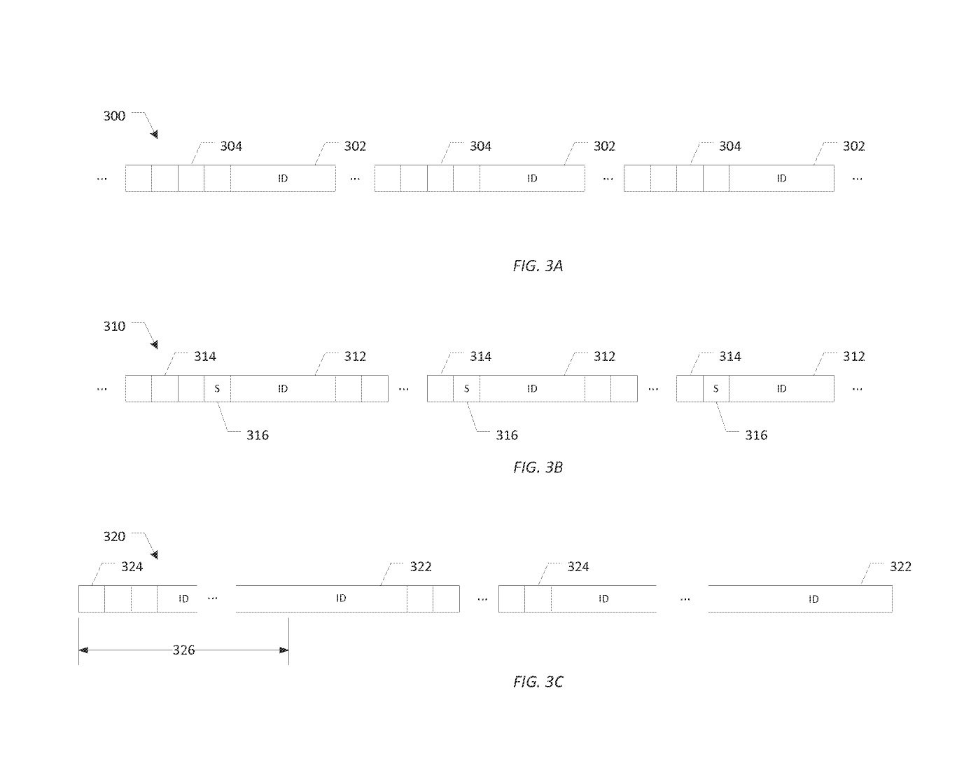

FIG. 3A illustrates an embodiment for locating an identifier pattern 302 in any given portion of a digital content 300. An identifier pattern 302 may be generated as described above, by interleaving segments from uniquely watermarked copies of the digital content 300. The identifier pattern 302 can be repeated periodically between the beginning and end of the digital content 300. The repeats of the identifier pattern 302 will be separated by segments 304 of the digital content 300 that are not part of the identifier pattern 302, either because they do not contain any watermark, or because they contain a watermark that is not associated with the identifier pattern 302, or because they contain a pattern for some other information. The repeats of the identifier pattern 302 can occur at even intervals or at differing intervals. The identifier pattern 302 can be located within any portion of the digital content 300 by identifying the segments 304 that are not part of the identifier pattern 302; the remaining data will contain the identifier pattern 302.

FIG. 3B illustrates an embodiment for locating an identifier pattern 312 in any given portion of a digital content 310. An identifier pattern 312 may be generated as described above, by interleaving segments from distinctly watermarked copies of the digital content 310. The identifier pattern can be repeated periodically between the beginning and end of the digital content 310. Each repeat of the identifier pattern 312 is preceded by a start indicator 316. The start indicator 316 can be distinguished in any number of ways, such as for instance by containing a watermark distinct from the watermarks that comprise the identifier pattern 312, or by itself having a unique pattern of segments, or by lacking a watermark, or any combination of the foregoing; the start indicator 316 need only be distinguishable and unique from the surrounding data. The start indicator 316 may immediately precede the identifier pattern 312 or may precede the identifier pattern 312 by some known amount of data. The repeats of the identifier pattern 312 may optionally be separated by segments 314 of the digital content that are not part of the identifier pattern 312. The repeats of the identifier pattern 312 can occur at even intervals or at differing intervals or continuously, without segments 314 in between. The identifier pattern 312 can be located within any portion of the digital content by locating a start indicator 316.

FIG. 3C illustrates an embodiment for locating an identifier pattern 322 in any given portion of a digital content 320. An identifier pattern 322 may be generated as described above, by interleaving segments from distinctly watermarked copies of the digital content 320. The identifier pattern can be repeated periodically between the beginning and the end of the digital content 320. The repeats of the identifier pattern 322 may optionally be separated by segments 324 of the digital content that are not part of the identifier pattern 322. The repeats of the identifier pattern 322 can occur at even intervals or at differing intervals or continuously, without segments 324 therebetween. The identifier pattern 322 can be located within any portion of the digital content 320 by determining the offset 326 of a given portion from the beginning of the digital content. The offset 326 can be determined by examining the data of the given portion of the digital content and extracting, for example, a logical offset such as a page count or video frame (as determined by the content of the data), or a number of seconds since start such as with audio data, or a bit or byte count, or a data stamp or time stamp embedded in the data, or the location within the identifier pattern 322. Obtaining the offset 326 of the given portion of the digital content allows an operator to determine what portion of the identifier pattern 322 is contained within the given portion, or else where in the portion to locate the identifier.

Although the embodiments of FIGS. 3A-3C are illustrated separately for clarity of disclosure, it is understood that the illustrated embodiments can be used in any combination.

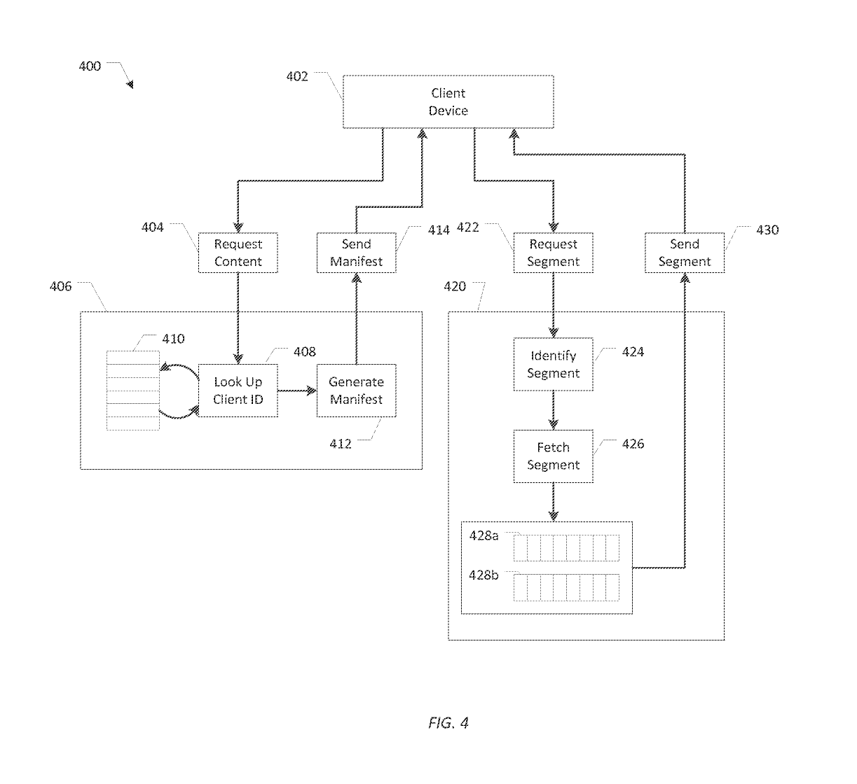

FIG. 4 illustrates a process 400 for delivering uniquely identifiable content using segmented watermark encoding employing a manifest manipulator 406 according to one embodiment. A client device 402 requests 404 digital content. The client device 402 can be any intermediate or final device or system capable of transmitting, processing, displaying, or making use of the digital content. The request 404 may be received by a manifest manipulator 406. The manifest manipulator 406 can look up 408 the client ID for the client device 402 by searching an ID table 410. The client ID is an identifier as described in FIGS. 1-2 above. Returning to FIG. 4, upon locating the client ID, the manifest manipulator 406 can generate 416 a manifest. The manifest contains a list of the segments that comprise the requested digital content, in the order that the segments appear within the digital content. The manifest manipulator 406 can generate 412 a manifest according to any of the embodiments illustrated in FIGS. 3A-3C, or any combination of these embodiments, such that the manifest includes an identifier pattern representing the client ID. Returning to FIG. 4, the manifest manipulator 406 can send 414 the manifest to the requesting client device 402. The manifest manipulator 406 can also store information about the request 404, such as the client ID, the content requested, the date and time the content was requested, as well as other information.

The client device 402 can use the manifest to request 422 segments of the digital content. A content server 420 can receive the requests 422 and identify 424 which segment has been requested. Identifying 424 the segment includes identifying which watermarked copy 428a or 428b the segment should come from, as well as the segment's order in the sequence of segments that comprise the digital content. Having identified 424 the requested segment, the content server 420 can fetch 426 the proper segment from a watermarked copy 428a-428b or from another, possibly unwatermarked, copy. Upon fetching 426 the desired segment, the content server 420 can send 430 the segment to the requesting client device 402. The client device 402 will continue requesting 422 segments in the order specified by the manifest until it has received all of the requested digital content or until the client device 402 is interrupted.

Although the manifest manipulator 406 and content server 420 are illustrated as separate entities, they can be implemented by a single entity or multiple entities. The manifest manipulator 406 and the content server can be implemented in hardware, software, or any combination thereof. FIG. 4 also illustrates two watermarked copies 428a-428b by way of example only, and as discussed above an embodiment can employ any number of watermarked copies.

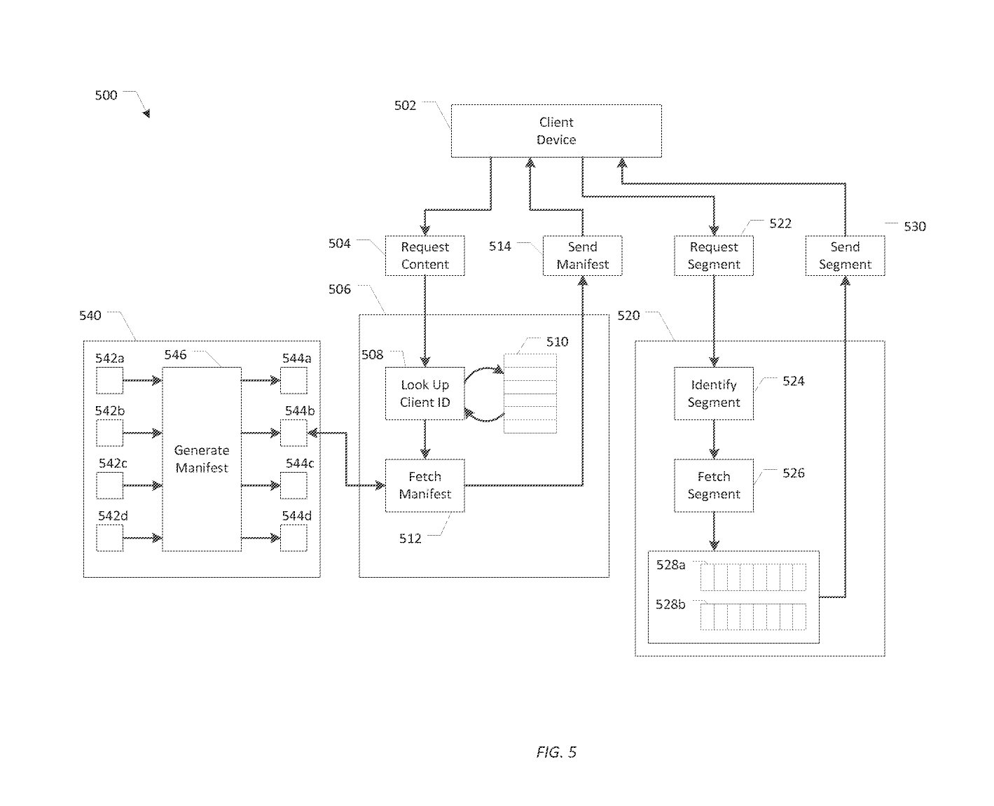

FIG. 5 illustrates a process 500 for delivering uniquely identifiable content using segmented watermark encoding employing a manifest selector 506 according to one embodiment. The process 500 includes a manifest generator 540. The manifest generator 540 will receive a number of client IDs 542a-542d and for each of these client IDs 542a-542d generate 545 manifests 544a-544d as described above. The client IDs are identifiers as described in FIGS. 1-2 above. Returning to FIG. 5, the manifest generator 540 generates 546 manifests according to any of the embodiments illustrated in FIGS. 3A-3C, or any combination of these embodiments, such that each manifest includes the identifier pattern representing a specific client ID.

As illustrated, a client device 502 requests 504 digital content. The request 504 may be received by a manifest selector 506, which can look up 508 the client ID for the client device 502 by searching an ID table 510. Upon locating the client ID, the manifest selector can fetch 512 a previously-generated manifest 544a-544d for the client ID. The manifest selector can send 514 the manifest to the requesting client device 502. The manifest selector 560 can also store information about the request 504, such as the client ID, the content requested, the date and time the content was requested, as well as other information.

The client device 502 can use the manifest to request 522 segments of the digital content. A content server 520 can receive the requests 522 and identify 524 which segment has been requested. Having identified 524 the requested segment, the content server 520 can fetch 526 the proper segment from a watermarked copy 528a-528b or from another, possibly unwatermarked copy. Upon fetching the desired segment the content server can send 530 the segment to the requesting client device 502. The client device 502 will continue requesting 522 segments in the order specified by the manifest until it has received all of the requested digital content or until the client device 502 is interrupted.

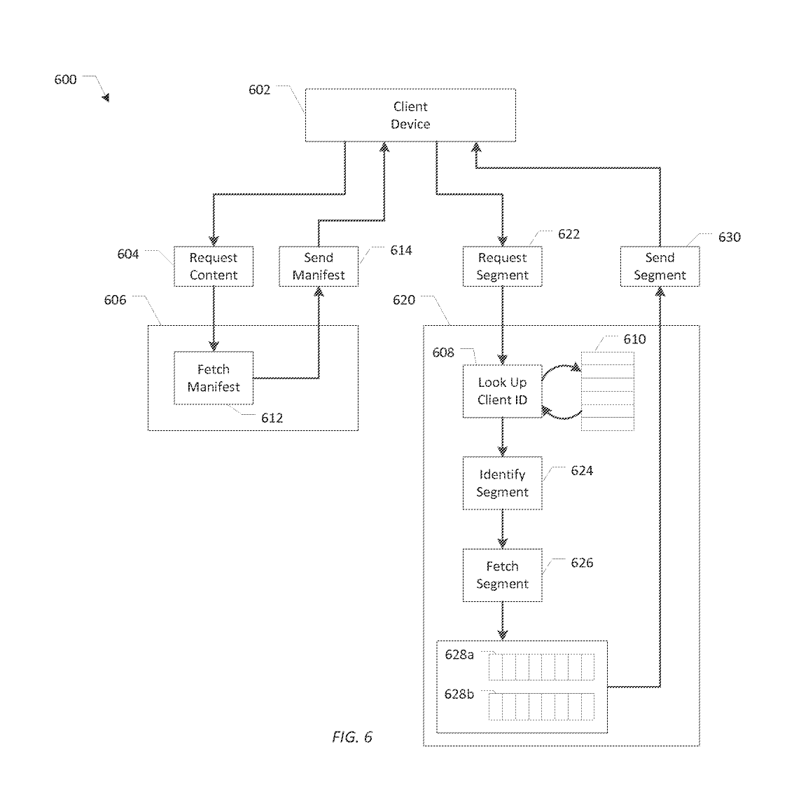

FIG. 6 illustrates a process 600 for delivering uniquely identifiable content using segmented watermark encoding employing a session proxy according to one embodiment. A client device 602 requests 604 digital content. The request 604 can be received by a manifest server 606. The manifest server 606 has access to manifests that have not been modified to incorporate identifiers as described above. The manifest server 606 will fetch 612 the correct manifest and send 614 the manifest to the requesting client device 602. The client device 602 can use the manifest to request 622 segments of the digital content. A session proxy 620 can receive the requests 622. The session proxy 620 can look up 608 the client ID for the client device 602 in an ID table 610. The client ID is an identifier as described in FIGS. 1-2 above. The session proxy 620 can use the client ID and the requested 622 segment to identify 624 which segment to fetch 626: the segment identifies which segment is next in the sequence, while the client ID identifies the source of the next segment. Thus the client ID will indicate whether the next segment to be fetched 626 should come from one watermarked copy 628a or another watermarked copy 628b or from another, possibly unwatermarked, copy. Upon fetching 626 the proper segment, the session proxy 620 can send 630 the segment to the requesting client device 602. The client device 602 will continue requesting 622 segments in the order specified by the manifest until it has received all of the requested digital content or until the client device 602 is interrupted.

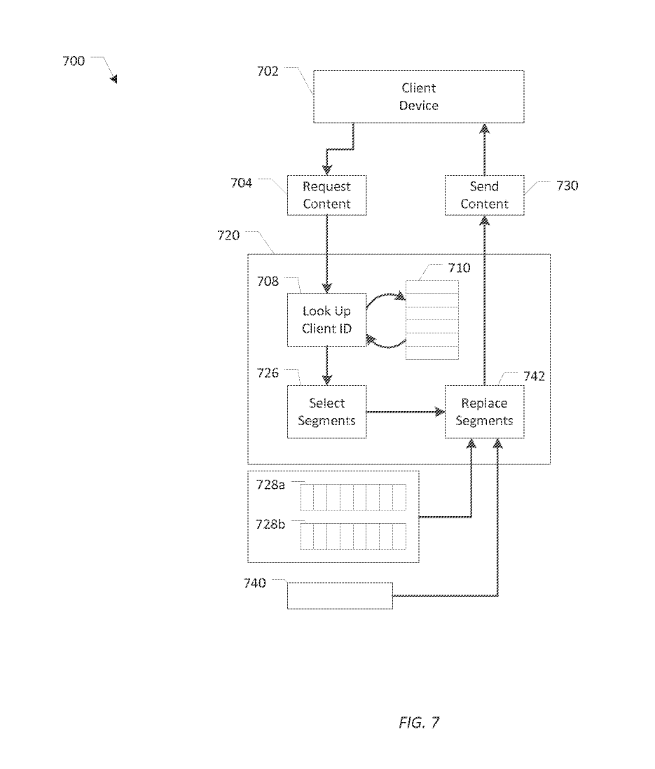

FIG. 7 illustrates a process 700 for delivering uniquely identifiable content using a Multiple Program Transport Stream (MPTS) server 720 according to one embodiment. An MPTS is a transport stream capable of containing one or more program services. A client device 702 requests 704 digital content. The request 704 may be received by an MPTS server 720. The MPTS server 720 can look up 708 the client ID for the client device 702 by searching an ID table 710. The client ID is an identifier as described in FIGS. 1-2 above. The MTPS server 720 can use the client ID to select 726 which segments should comprise the requested digital content by employing any of the embodiments of FIGS. 3A-3C or any combination thereof. The MPTS server 720 will have access to an unmodified copy 740 of the requested digital content, as well as watermarked copies 728a-728b of the digital content. Using a logical content system, the MPTS server 720 can be operable to replace 742 segments of data from the unmodified copy 742 of the digital content with appropriate segments from watermarked copies 728a-728 of the digital content, or another, possibly unwatermarked copy. The result of the replacement 742 operation will be a uniquely identifiable copy of the digital content. The MPTS server can be operable to send 730 all of the uniquely identifiable copy of the digital content, or to send 730 it in segments.

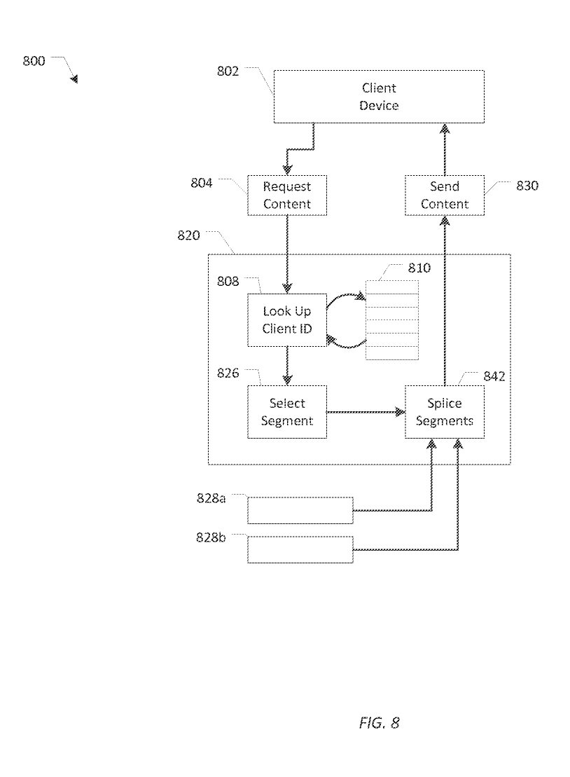

FIG. 8 illustrates a process 800 for delivering uniquely identifiable content using an MTPS splicer according to one embodiment. A client device 802 requests 804 digital content. The request 804 may be received by an MPTS splicer 820. The MPTS splicer can look up 808 the client ID for the client device 802 by searching an ID table 810. The client ID is an identifier as described in FIGS. 1-2 above. The MPTS splicer 720 can use the client ID to select 826 which segments should comprise the requested digital content by employing any of the embodiments of FIGS. 3A-3C or any combination thereof. The MPTS splicer has access to watermarked copies 828a-828b of the digital content. The MPTS splicer 820 can be operable to splice 842 segments of the watermarked copies 828a-828b, as well as other, possibly unwatermarked copies, to generate a uniquely identifiable copy of the digital content. The MPTS splicer can be operable to send 830 all of the uniquely identifiable copy of the digital content, or send 830 it in segments.

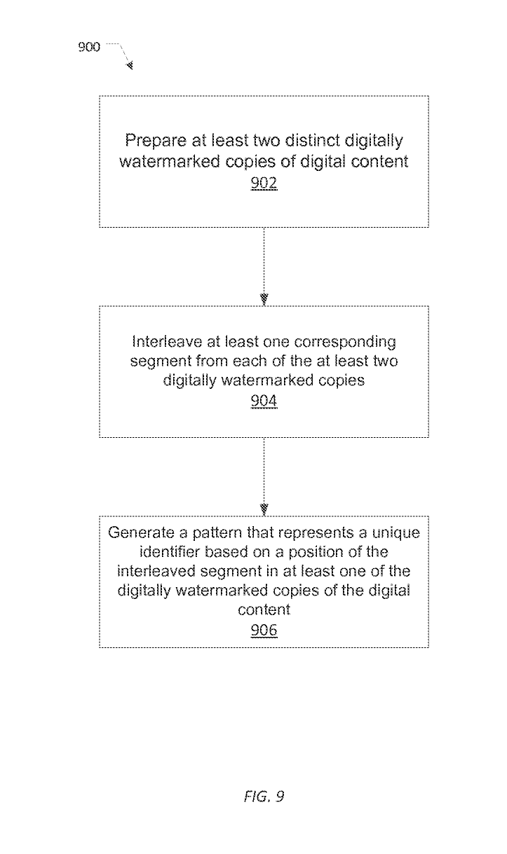

FIG. 9 illustrates a logic diagram of a computer-implemented method 900 for delivering uniquely identifiable content according to one embodiment. A content server comprising a processor and memory coupled to the processor is configured to execute the method. The memory stores program instructions, which when executed from the memory cause the processor to prepare 902 at least two distinct digitally watermarked copies of digital content, wherein each one of the at least two digitally watermarked copies comprises a distinct digital watermark, and wherein each one of the at least two digitally watermarked copies comprises a plurality of distinct segments. The processor interleaves 904 at least one corresponding segment from at least one of the at least two digitally watermarked copies. The processor generates 906 a pattern that represents a unique identifier based on a position of the interleaved segment in at least one of the digitally watermarked copies of the digital content. In one embodiment of the computer-implemented method 900, the processor may be configured to receive the digital content or create the digital content prior to preparing the at least two distinct digitally watermarked copies of digital content.

In one embodiment of the computer-implemented method 900, the processor may be configured to generate a plurality of patterns, wherein each of the plurality of patterns represents a unique identifier.

In another embodiment of the computer-implemented method 900, the processor may be configured to receive a request for the digital content and identify the unique identifier associated with the request. The processor also may transmit the requested segments of the at least one digitally watermarked copy according to the pattern.

In various embodiments of the computer-implemented method 900, the processor may be configured to repeat the pattern that represents the unique identifier between a beginning and end of the at least one of the digitally watermarked copies of the digital content, mark the beginning of the pattern that represents the unique identifier with a start indicator, and/or insert a timestamp into each one of the plurality of segments, wherein the timestamp identifies an offset of the times-tamped segment from the start of the digital content.

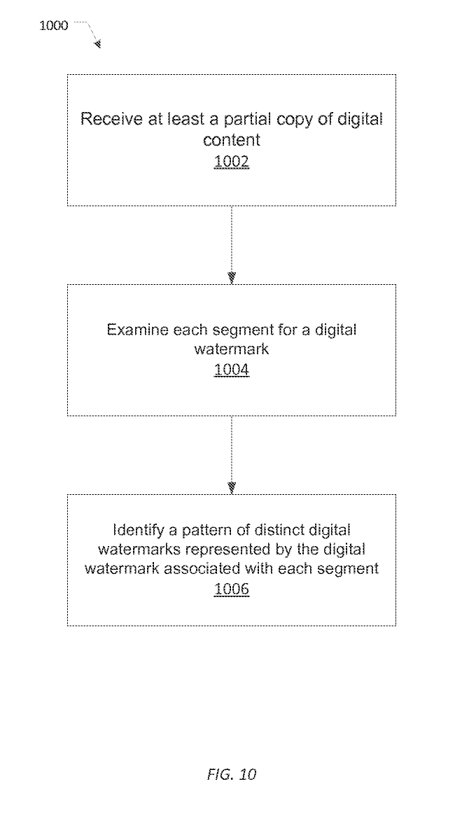

FIG. 10 illustrates a logic diagram of a computer-implemented method 1000 for identifying uniquely identifiable content according to one embodiment. A computer comprising a processor and memory coupled to the processor is configured to execute the method. The memory stores program instructions, which when executed from the memory cause the processor to receive 1002 a copy of digital content. The copy of the digital content may comprise a complete copy of the original digital content, a partial copy, or multiple partial copies, possibly concatenated together. As described above, the copy of the digital content may be divided into multiple segments. The processor examines 1004 each segment of the received 1002 copy for a digital watermark. The processor identifies 1006 a pattern of distinct digital watermarks represented by the digital watermark associated with each segment. As described above, each segment may contain a distinct, identifiable watermark. The same or different digital watermarks may be associated with certain segments of the digital content, such that the pattern of the distinct digital watermarks represents a unique identifier, as illustrated in FIGS. 1 and 2. The processor may be operable to locate the pattern by implementing any of the methods illustrated in FIGS. 3A-3C, any combination thereof, or any other suitable method.

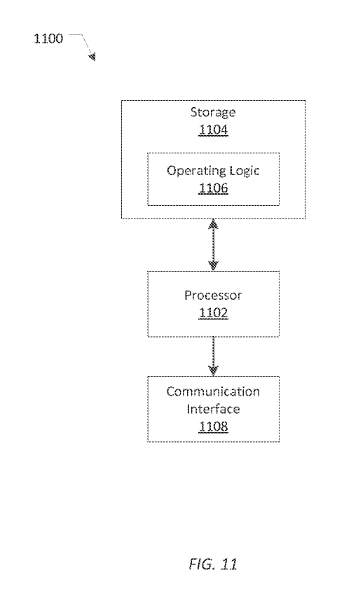

FIG. 11 illustrates an architectural or component view of a computing system 1100 that may be employed with the computer-implemented method 900 for delivering uniquely identifiable content according to one embodiment. In various embodiments, the computing system 1100 comprises one or more processors 1102 (such as for instance a microprocessor or microcontroller). The computing system 1100 further comprises a storage 1104, having operating logic 1106, in coupled to the one or more processors 1102. The computing system further comprises a communication interface 1108 coupled to the one or more processors 1102.

The processor 1102 may be configured to execute the operating logic 1106. The processor 1102 may be any one of a number of single or multi-core processors known in the art. The storage 1106 may comprise volatile and non-volatile storage media configured to store persistent and temporal copies of the operating logic 1106.

In various embodiments, the operating logic 1106 may be configured to generate a pattern that represents a unique identifier according to computer-implemented method 900. In some embodiments, the operating logic 1106 may be configured to prepare at least two distinct digitally watermarked copies of digital content. In various embodiments, the operating logic 1106 may further be configured to interleave at least one corresponding segment from at least one of the at least two digitally watermarked copies. In various embodiments, the operating logic 1106 may further be configured to generate a patter that represents a unique identifier based on a position of the interleaved segment in at least on of the digitally watermarked copies of the digital content.

In various embodiments, the operating logic 1106 may be implemented in instructions supported by the instruction set architecture (ISA) of the processor 1102, or in higher level languages and compiled into the supported ISA. The operating logic 1106 may comprise on or more logic units or modules. The operating logic 1106 may be implemented in an object oriented manner. The operating logic 1106 may be configured to be executed in a multi-tasking and/or multi-threaded manner. In other embodiments, the operating logic 1106 may be implemented in hardware, such as a gate array.

In various embodiments, the communication interface 1108 may be configured to facilitate communication between external systems or network-connected systems and the computing system 1100. The communication may include transmission of the at least two distinct digitally watermarked copies and/or the pattern that represents a unique identifier. In various embodiments, the communication interface 1108 may be a wired or a wireless communication interface. An example of a wired communication interface may include, but is not limited to, a serial interface, a parallel interface, an Ethernet interface, or a Universal Serial Bus (USB) interface. An example of a wireless communication interface may include, but is not limited to, an interface implementing any variant of the 802.11 wireless protocol, an interface implementing a cellular network protocol, or a Bluetooth interface.

For various embodiments, the processor 1102 may be packaged together with the operating logic 1106. In various embodiments, the processor 1102 may be packaged together with the operating logic 1106 to form a System in Package (SiP). In various embodiments, the processor 1102 may be integrated on the same die with the operating logic 1106. In various embodiments, the processor 1102 may be packaged together with the operating logic 1106 to form a System on Chip (SoC).

While various details have been set forth in the foregoing description, it will be appreciated that the various aspects of content traceability using segmented watermark encoding may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

Some or all of the embodiments described herein may generally comprise technologies for various aspects of content traceability using segmented watermark encoding, or otherwise according to technologies described herein. In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. Those skilled in the art will recognize, however, that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

1. A computer-implemented method, comprising:
preparing, by a computer, at least two distinct digitally watermarked copies of digital content, wherein each one of the at least two digitally watermarked copies comprises a distinct digital watermark, and wherein each one of the at least two digitally watermarked copies comprises a plurality of distinct segments;
interleaving, by the computer at least one corresponding segment from at least one of the at least two digitally watermarked copies; and
generating, by the computer, a pattern that represents a unique identifier based on a position of the interleaved segment in at least one of the digitally watermarked copies of the digital content.

2. The computer-implemented method of claim 1, further comprising generating, by the computer, a plurality of patterns, wherein each of the plurality of patterns represents a unique identifier.

3. The computer-implemented method of claim 1, further comprising:
receiving, by the computer, a request for the digital content or a plurality of distinct segments of the at least one of the digitally watermarked copies;
identifying, by the computer, the unique identifier associated with the request;
transmitting, by the computer, the requested digital content based on the unique identifier or transmitting the requested segments of the at least one digitally watermarked copy according to the pattern.

4. The computer-implemented method of claim 1, further comprising repeating, by the computer, the pattern that represents the unique identifier between a beginning and end of the at least one of the digitally watermarked copies of the digital content.

5. The computer-implemented method of claim 1, further comprising marking, by the computer, the beginning of the pattern that represents the unique identifier with a start indicator.

6. The computer-implemented method of claim 1, further comprising inserting, by the computer, a timestamp into each one of the plurality of segments, wherein the timestamp identifies an offset of the time-stamped segment from the start of the digital content.

7. The computer-implemented method of claim 1, further comprising receiving, by the computer, or creating, by the computer, the digital content.

8. An apparatus, comprising:
a processor; and
a memory coupled to the processor, wherein the memory stores program instructions, which when executed from the memory cause the processor to:
prepare at least two distinct digitally watermarked copies of digital content, wherein each one of the at least two digitally watermarked copies comprises a distinct digital watermark, and wherein each one of the at least two digitally watermarked copies comprises a plurality of distinct segments;
interleave at least one corresponding segment from at least one of the at least two digitally watermarked copies; and
generate a pattern that represents a unique identifier based on a position of the interleaved segment in at least one of the digitally watermarked copies of the digital content.

9. The apparatus of claim 8, wherein the stored program instructions, when executed by the processor, cause the processor to generate a plurality of patterns, wherein each of the plurality of patterns represents a unique identifier.

10. The apparatus of claim 8, wherein the stored program instructions, when executed by the processor, cause the processor to:
receive a request for the digital content or a request for the plurality of distinct segments of at least one of the digitally watermarked copies;
identify the unique identifier associated with the request; and
transmit the requested digital content based on the unique identifier or
transmit the requested segments of the at least one digitally watermarked copy according to the pattern.

11. The apparatus of claim 8, wherein the stored program instructions, when executed by the processor, cause the processor to repeat the pattern that represents the unique identifier between a beginning and end of the at least one of the digitally watermarked copies of the digital content.

12. The apparatus of claim 8, wherein the stored program instructions, when executed by the processor, cause the processor to mark the beginning of the pattern that represents the unique identifier with a start indicator.

13. The apparatus of claim 8, wherein the stored program instructions, when executed by the processor, cause the processor to insert a timestamp into each one of the plurality of segments, wherein the timestamp identifies an offset of the time-stamped segment from the start of the digital content.

14. The apparatus of claim 8, wherein the stored program instructions, when executed by the processor, cause the processor to receive or create the digital content.

15. A system, comprising:
a digital content server configured to create and deliver uniquely identifiable copies of digital content, the digital content server comprising:
a processor; and
a memory coupled to the processor, wherein the memory stores program instructions, which when executed from the memory cause the processor to:
prepare at least two distinct digitally watermarked copies of digital content, wherein each one of the at least two digitally watermarked copies comprises a distinct digital watermark, and wherein each one of the at least two digitally watermarked copies comprises a plurality of distinct segments;
interleave at least one corresponding segment from at least one of the at least two digitally watermarked copies; and
generate a pattern that represents a unique identifier based on a position of the interleaved segment in at least one of the digitally watermarked copies of the digital content.

16. The system of claim 15, further comprising a manifest manipulator, wherein the manifest manipulator is configured to generate a manifest of the segments comprising the digital content, incorporating the pattern that represents a unique identifier, and transmit the manifest.

17. The system of claim 15, further comprising a manifest selector, wherein the manifest selector is configured to select a manifest of the segments comprising the digital content, wherein the manifest incorporates the pattern that represents a unique identifier, and transmit the manifest.

18. The system of claim 15, further comprising a session proxy, wherein the session proxy is configured to select among the at least two digitally watermarked copies according to the pattern that represents a unique identifier, in response to requests for segments of the digital content.

19. The system of claim 15, further comprising a Multiple Program Transport Stream (MPTS) server, wherein the MPTS server is configured to replace segments of the digital content with segments from the at least two digitally watermarked copies according to the pattern that represents a unique identifier.

20. The system of claim 15, further comprising Multiple Program Transport Stream (MPTS) splicer, wherein the MPTS splicer is configured to splice segments of the at least two digitally watermarked copies according to the pattern that represents a unique identifier.

21. A computer-implemented method, comprising:
receiving, by a computer, at least a partial copy of digital content, wherein the copy of the digital content comprises a plurality of distinct segments;
examining, by the computer, each segment for a digital watermark;
identifying, by the computer, a pattern of distinct digital watermarks represented by the digital watermark associated with each segment, wherein the pattern represents a unique identifier.

22. The computer-implemented method of claim 21, further comprising locating the pattern that represents the unique identifier within the copy of the digital content by identifying a repeating pattern of unique digital watermarks.

23. The computer-implemented method of claim 21, further comprising locating the pattern that represents the unique identifier within the copy of the digital content by identifying a start indicator.

24. The computer-implemented method of claim 21, further comprising locating the pattern that represents the unique identifier within the copy of the digital content by identifying a timestamp associated with a segment, wherein the timestamp identifies an offset of the time-stamped segment from the start of an original copy of the digital content.

25. An apparatus, comprising:
a processor; and
a memory coupled to the processor, wherein the memory stores program instructions, which when executed from the memory cause the processor to:
receive at least a partial copy of digital content, wherein the copy of the digital content comprises a plurality of distinct segments;
examine each segment for a digital watermark;
identify a pattern of distinct digital watermarks represented by the digital watermark associated with each segment, wherein the pattern represents a unique identifier.

26. The apparatus of claim 25, wherein the stored program instructions, when executed by the processor, cause the processor to locate the pattern that represents the unique identifier within the copy of the digital content by identifying a repeating pattern of distinct digital watermarks.

27. The apparatus of claim 25, wherein the stored program instructions, when executed by the processor, cause the processor to locate the pattern that represents the unique identifier within the copy of the digital content by identifying a start indicator.

28. The apparatus of claim 25, wherein the stored program instructions, when executed by the processor, cause the processor to locate the pattern that represents the unique identifier within the copy of the digital content by identifying a timestamp associated with a segment, wherein the timestamp identifies an offset of the time-stamped segment from the start of an original copy of the digital content.
